(19) United States
(12) Patent Application Publication
(10) Pub. No.: US 2018/0336069 A1
(43) Pub. Date: Nov. 22, 2018

(54) SYSTEMS AND METHODS FOR A HARDWARE AGNOSTIC VIRTUAL EXPERIENCE

(71) Applicant: Tsunami VR, Inc., Del Mar, CA (US)

(72) Inventor: Naresh SONI, San Diego, CA (US)

(21) Appl. No.: 15/975,055

(22) Filed: May 9, 2018

Related U.S. Application Data
(60) Provisional application No. 62/507,419, filed on May 17, 2017.

(51) Int. Cl. G06F 9/50; G06F 12/0875; G06T 19/00; H04L 29/06

(52) U.S. Cl. CPC G06F 9/5055; G06F 12/0875; H04L 67/42; H04L 63/08; G06T 19/006

(57) ABSTRACT

A hardware agnostic virtual experience. Particular systems and methods develop a virtual service, encode the virtual service in a proprietary encoder format, and publish the encoded virtual service to a content management server. Requests for the virtual service are received from the different requestor devices on which a runtime library is installed as an abstraction layer. Users of the requestor devices are authenticated to ensure that the users have the appropriate clearance for the virtual service, and if so, virtual content of the virtual service is provided to the requestor devices, which in turn provide the virtual content to one or more display devices that are connected to or part of the requestor devices.

### RELATED APPLICATIONS

This application relates to the following related application(s): U.S. Pat. Appl. No. 62/507,419, filed May 17, 2017, entitled METHOD AND APPARATUS FOR A HARDWARE AGNOSTIC AR/VR EXPERIENCE. The content of each of the related application(s) is hereby incorporated by reference herein in its entirety.

### TECHNICAL FIELD

This disclosure relates to virtual training, collaboration or other virtual technologies.

### BRIEF DESCRIPTION OF THE DRAWINGS

FIG. 1A and FIG. 1B depict aspects of a system on which different embodiments are implemented for a hardware agnostic virtual experience.

FIG. 2 depicts a method for a hardware agnostic virtual experience.

FIG. 3 shows a block diagram of a device utilizing a runtime library for a hardware agnostic virtual experience.

FIG. 4 shows a block diagram of a runtime library for a hardware agnostic virtual experience.

### DETAILED DESCRIPTION

This disclosure relates to different approaches for a hardware agnostic virtual experience.

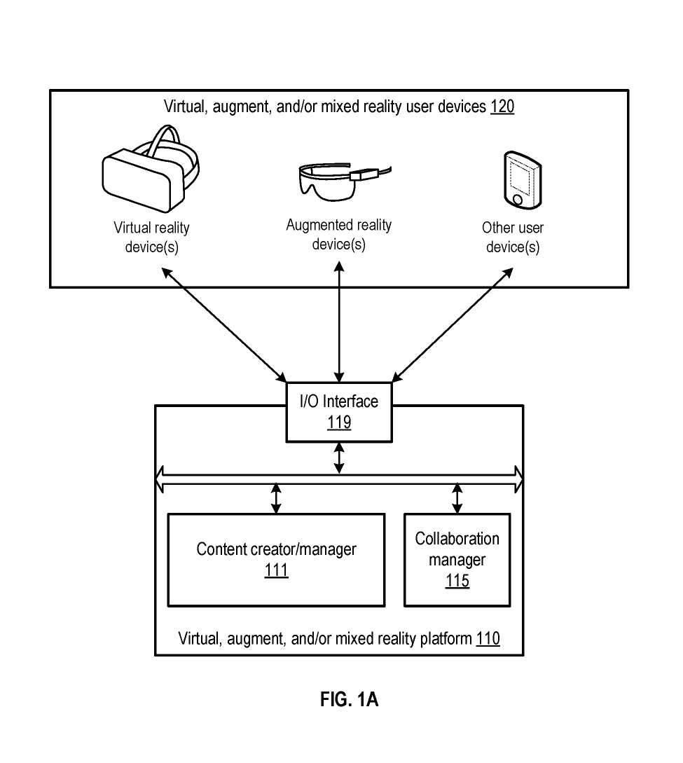

FIG. 1A and FIG. 1B depict aspects of a system on which different embodiments are implemented for a hardware agnostic virtual experience. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for a hardware agnostic virtual experience are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for a hardware agnostic virtual experience.

### Hardware Agnostic Virtual Experience

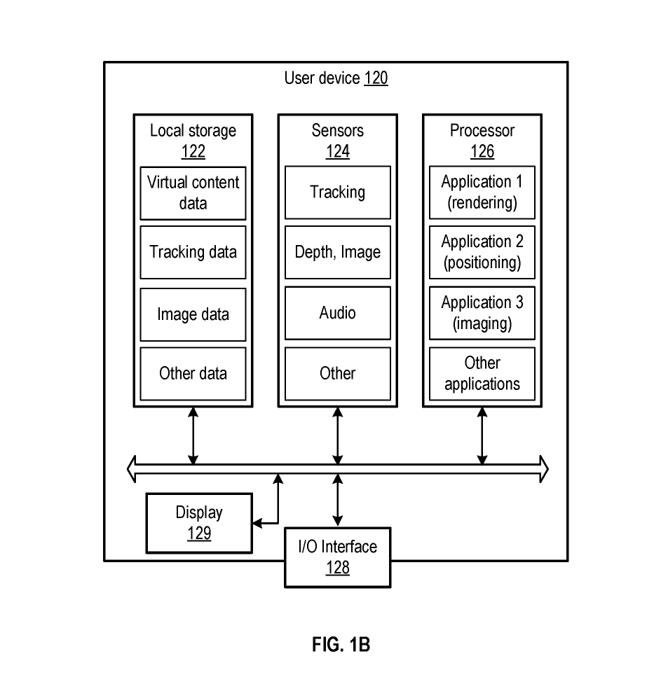

FIG. 2 depicts a method for a hardware agnostic virtual experience. The method comprises: developing a virtual service (201); encoding the virtual service in a proprietary encoder format (203); publishing the encoded virtual service to a content management server (205); installing, on a first requestor device, a runtime library as an abstraction layer (207); receiving, from the first requestor device, a first request for the virtual service (209); authenticating a first user of the first requestor device to ensure that the first user has the appropriate clearance for the virtual service (211); providing virtual content to the first requestor device (213); and providing the virtual content to a first display device that is connected to or part of the first requestor device (215).

In one embodiment of the method depicted in FIG. 2, the runtime library provides for display of the virtual content on each of a plurality of display devices.

In one embodiment of the method depicted in FIG. 2, the method further comprises: installing, on a second requestor device, the runtime library as the abstraction layer; receiving, from the second requestor device, a second request for the virtual service; authenticating a second user of the second requestor device to ensure that the second user has the appropriate clearance for the virtual service; providing the virtual content to the second requestor device; and providing the virtual content to a second display device that is connected to or part of the second requestor device. Examples of the first requestor device include a desktop computer, a laptop computer, a mobile phone, or a tablet computer that includes a first display as the first display device. Examples of the second requestor device include a virtual or augmented reality headset that includes a second display as the second display device.

In one embodiment of the method depicted in FIG. 2, the method further comprises: providing the virtual content from the first requestor device to a plurality of display devices, where the plurality of display devices includes an augmented or virtual reality user device and another user device selected from the group consisting of a personal computer, a laptop computer, a tablet computer, or a mobile phone with a two-dimensional display.

In one embodiment of the method depicted in FIG. 2, the first requestor device is a personal computer, laptop computer, tablet computer or mobile phone, and the first display device is a two-dimensional display of the first requestor device.

In one embodiment of the method depicted in FIG. 2, the first requestor device is a stationary or mobile computer, and the first display device is not a display of the first requestor device.

In one embodiment of the method depicted in FIG. 2, the method further comprises: compressing the virtual content prior to providing the virtual content to the first display device.

In one embodiment of the method depicted in FIG. 2, the runtime library comprises a device abstraction layer API, a graphic renderer API, a file and network API, a battery API, a network level API and a cache. By way of example: the device abstraction layer API is a sub-component dedicated to a first set of system operations; the graphic renderer API is a sub-component dedicated to graphic input/output operations (e.g., at least one of a compositor, an overlay, a rendering, or a screenshot); the file and network API is a sub-component dedicated to file and network input and output; the battery API is used to measure battery power; the network level API is used to detect network availability, type of network, and link quality; and/or the cache stores a frequently used scene or a plurality of frequently used scenes.

In one embodiment of the method depicted in FIG. 2, the first request for the virtual service from the first requestor device is received using an Internet protocol.

A system for providing a hardware agnostic virtual experience is also contemplated where the system comprises: a first device comprising a runtime library including a device abstraction layer API, a graphic renderer API, a file and network API, a battery API, a network level API and a cache; a content management server comprising virtual content; a plurality of display devices.

In one embodiment of the system, the plurality of display devices includes an augmented or virtual reality device and another display device selected from the group consisting of a personal computer, a laptop computer, a tablet computer, or a mobile phone with a two-dimensional display.

In one embodiment of the system, the runtime library provides for display of the virtual content on each of the plurality of display devices.

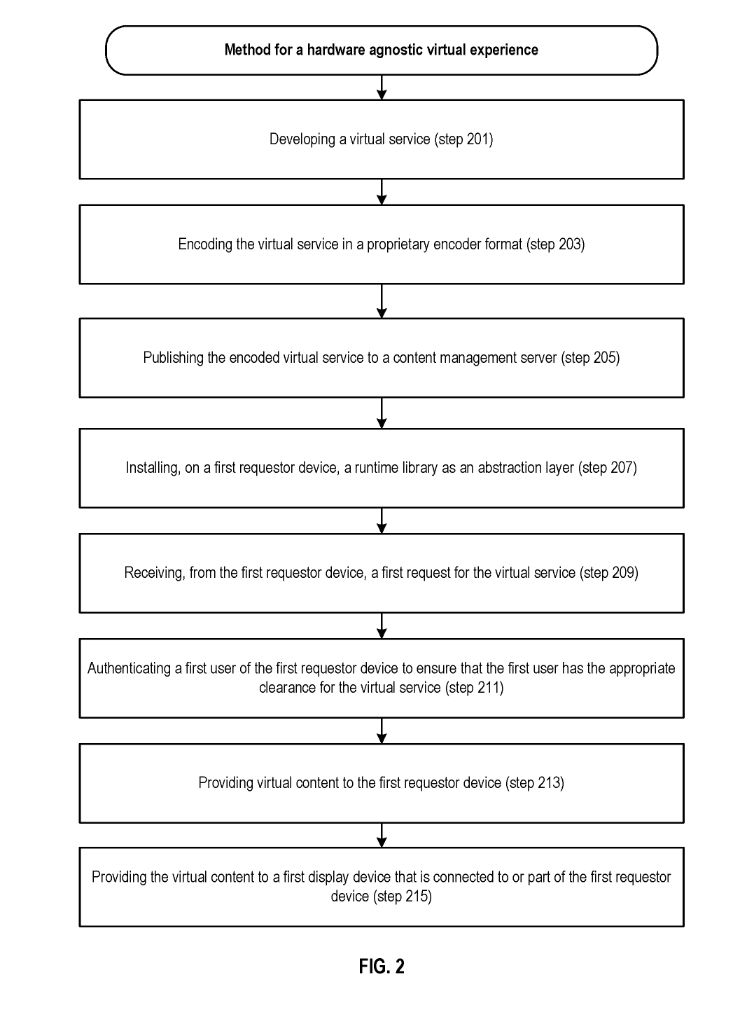

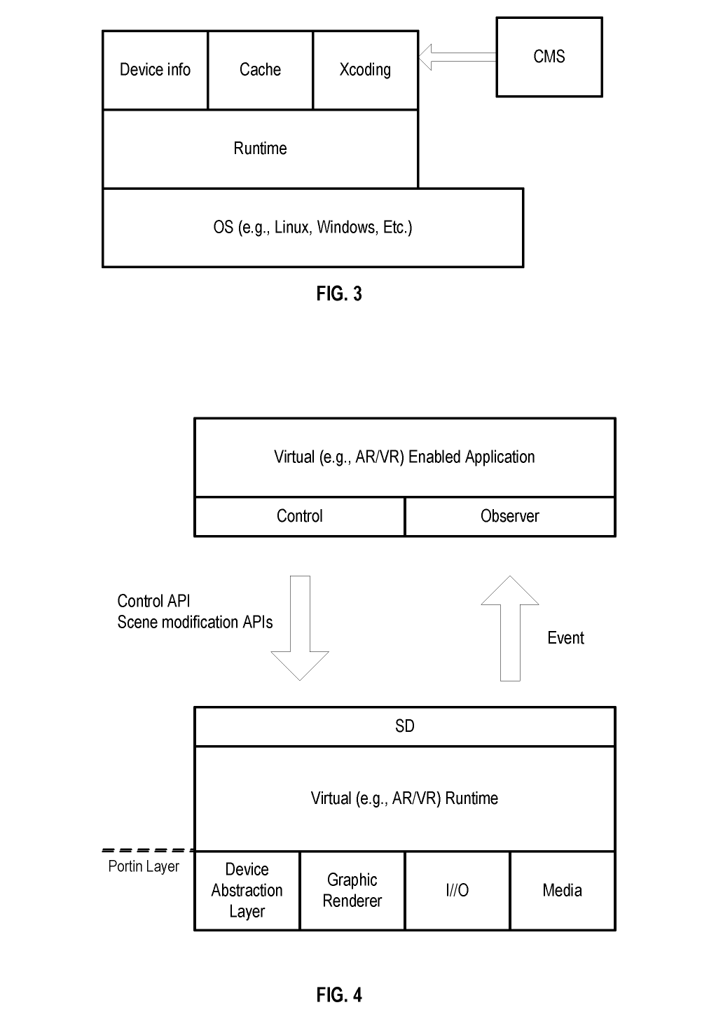

FIG. 3 shows a block diagram of a device utilizing a runtime library for a hardware agnostic virtual experience that is discussed below. FIG. 4 shows a block diagram of a runtime library for a hardware agnostic virtual experience that is discussed below.

Aspects described below support content delivery to any user device. The key principle of an abstraction layer is to “develop once and use it in multiple environments and devices.”

One embodiment is a method for hardware an agnostic virtual (e.g., AR/VR) experience. The method includes developing a virtual (e.g., AR/VR) service. The method also includes encoding the virtual (e.g., AR/VR) service in a proprietary encoder format. The method also includes publishing the encoded virtual (e.g., AR/VR) service to a content management server. The method also includes installing a runtime library on the requestor device as an abstraction layer. The method also includes requesting service from the requestor device using an Internet protocol. The method also includes authenticating the user to ensure that the user has the appropriate clearance for the requested service. The method also includes streaming the content to the requestor device. The method also includes transmitting the content from the requestor device to a display device.

Another embodiment is a system for hardware an agnostic virtual (e.g., AR/VR) experience. The system comprises a primary device, a content management server, and a plurality of display devices. The primary device comprises a runtime library comprising a device abstraction layer API, a graphic renderer API, a file and network API, a battery API, a network level API and a cache. The content management server comprises a plurality of virtual (e.g., AR/VR) content. The runtime library allows for display of the content from the on each of the plurality of display devices in multiple environments.

A virtual (e.g., AR/VR) service is developed and then encoded in an encoder format, then published on a cloud. The service is published to the Content Management Server (CMS). Appropriate content is then requested using http or other protocol. A CDN such as Akamai or Microsoft Azure may be used. The content is then streamed to either a PC, display device directly or to a console (gaming, briefing center).

The virtual (e.g., AR/VR) runtime is a library that reads content packaged by the developer during compilation of the scenes and transmitted over to a head mounted device, which produces virtual (e.g., AR/VR) experiences and includes graphics, audio or video output according to the scene specifications. This runtime would be installed on a user's PC to provide an abstraction layer regardless of the type of device used. The transmission can be over a wireless link or a cable.

A virtual enabled application is a program that is able to display and play the content through the virtual runtime. The specification should be designed to allow efficient representation of 3D scenes describing virtual (e.g., AR/VR) services for head mounted devices. In one embodiment, a virtual (e.g., AR/VR) service is a dynamic and interactive presentation comprising any of 3D vector graphics, images, text and/or audiovisual materials. The representation of such a presentation includes describing the spatial and temporal organization of different elements as well as its possible interactions and animations. Also, the content that is downloaded to the headset should be compressed efficiently to reduce overall bandwidth. Efficient compression improves delivery and decoding times, as well as storage size and is achieved by a compact binary representation. Virtual (e.g., AR/VR) streams should be low overhead multiplexed streams which can be delivered using any delivery mechanism: download-and-play, progressive download, streaming or broadcasting. To achieve efficiency, a cache unit allows sending in advance sub-content which will be used later on in the presentation.

Some components utilized with the embodiments described herein comprise PCs, head-mounted displays (HMDs) from HTC, Microsoft, Windows/MAC OS, and Cloud computing service.

The encoding format encodes the VR/AR content in a proprietary format.

The runtime library enables hardware specific functions.

The hardware abstraction layer encapsulates hardware functions.

The cache accelerates rendering of VR/AR content.

In the different embodiments described herein, the virtual runtime may be instantiated and initialized by giving it an off-screen buffer.

The method also provides the virtual runtime with a Uniform Resource Name (URN) of a link on the cloud to open, which is a link to open on the cloud.

A method for hardware an agnostic virtual (e.g., AR/VR) experience includes developing a virtual (e.g., AR/VR) service. At a next step, the virtual (e.g., AR/VR) service is encoded in a proprietary encoder format. At a next step, the encoded virtual (e.g., AR/VR) service is published to a content management server. At a next step, a runtime library is installed on the requestor device as an abstraction layer. At a next step, the virtual (e.g., AR/VR) service is requested from the requestor device using an Internet protocol. At a next step, the user is authenticated to ensure that the user has the appropriate clearance for the requested service. At a next step, the content is streamed to the requestor device. At a next step, the content is transmitted from the requestor device to a display device.

The method optionally includes transmitting the content from the requestor device to multiple display devices in multiple environments.

The method optionally includes compressing the content prior to transmission to the display device.

The requestor device is preferably a personal computer, laptop computer, tablet computer or mobile computing device.

The display device is preferably selected from the group comprising a desktop computer, a laptop computer, a tablet computer, a mobile phone, an augmented (AR) headset, and a virtual reality (VR) headset.

The runtime library preferably comprises a device abstraction layer API, a graphic renderer API, a file and network API, a battery API, a network level API and a cache.

The device abstraction layer API is preferably a sub-component dedicated to a first set of system operations (e.g., low level system operations).

The graphic renderer API is preferably a sub-component dedicated to graphic input/output operations.

The file and network API is preferably a sub-component dedicated to file and network input and output.

The battery API is utilized for measurement of battery power.

The network level API is preferably utilized to detect network availability, type of network (wireless or wireline), and/or link quality.

The cache is preferably utilized for storing a frequently used scene or a plurality of frequently used scenes.

The device abstraction preferably comprises at least one of a display, camera, tracking, haptics, calibration, interface type, sensors, external sensors, controls or chaperone.

The graphic renderer API is preferably at least one of a compositor, an overlay, a rendering, or a screenshot.

A system for hardware an agnostic virtual (e.g., AR/VR) experience preferably comprises a primary device, a content management server, and a plurality of display devices. The primary device may comprise a runtime library comprising a device abstraction layer API and a graphic renderer API, a file and network API, a battery API, a network level API and a cache. The content management server comprises a plurality of virtual (e.g., AR/VR) content. The runtime library allows for display of the content from the on each of the plurality of display devices in multiple environments.

The user interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the virtual (e.g., AR/VR) assets that are to be displayed. For each virtual (e.g., AR/VR) asset the author defines the order in which the assets are displayed. The assets can be displayed simultaneously or serially in a timed sequence. The author uses the virtual (e.g., AR/VR) assets and the display timeline to tell a “story” about the product. In addition to the timing in which virtual (e.g., AR/VR) assets are displayed, the author can also utilize techniques to draw the audience's attention to a portion of the presentation. For example, the author may decide to make a virtual (e.g., AR/VR) asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the virtual (e.g., AR/VR) assets are reduced to eliminate the need for the author to view the preview using virtual (e.g., AR/VR) headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's virtual (e.g., AR/VR) assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally a function would be built in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows an artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in virtual (e.g., AR/VR) (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story;=Assets inside an environment displayed over a timeline. User Experience element for creation and editing.

CMS Database: Inputs: Manages The Library, Any asset: virtual (e.g., AR/VR) Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human).

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for providing a hardware agnostic virtual experience, the method comprising:
developing a virtual service;
encoding the virtual service in a proprietary encoder format;
publishing the encoded virtual service to a content management server;
installing, on a first requestor device, a runtime library as an abstraction layer;
receiving, from the first requestor device, a first request for the virtual service;
authenticating a first user of the first requestor device to ensure that the first user has the appropriate clearance for the virtual service;
providing virtual content to the first requestor device; and
providing the virtual content to a first display device that is connected to or part of the first requestor device.

2. The method according to claim 1, wherein the runtime library provides for display of the virtual content on each of a plurality of display devices.

3. The method according to claim 1, further comprising:
installing, on a second requestor device, the runtime library as the abstraction layer;
receiving, from the second requestor device, a second request for the virtual service;
authenticating a second user of the second requestor device to ensure that the second user has the appropriate clearance for the virtual service;
providing the virtual content to the second requestor device; and
providing the virtual content to a second display device that is connected to or part of the second requestor device,
wherein the first requestor device is a desktop computer, a laptop computer, a mobile phone, or a tablet computer that includes a first display as the first display device, and
wherein the second requestor device is a virtual or augmented reality headset that includes a second display as the second display device.

4. The method according to claim 1, further comprising: providing the virtual content from the first requestor device to a plurality of display devices, wherein the plurality of display devices includes an augmented or virtual reality user device and another user device selected from the group consisting of a personal computer, a laptop computer, a tablet computer, or a mobile phone with a two-dimensional display.

5. The method according to claim 1, wherein the first requestor device is a personal computer, laptop computer, tablet computer or mobile phone, and the first display device is a two-dimensional display of the first requestor device.

6. The method according to claim 1, wherein the first requestor device is a stationary or mobile computer, and the first display device is not a display of the first requestor device.

7. The method according to claim 1, further comprising: compressing the virtual content prior to providing the virtual content to the first display device.

8. The method according to claim 1, wherein the runtime library comprises a device abstraction layer API, a graphic renderer API, a file and network API, a battery API, a network level API and a cache.

9. The method according to claim 8, wherein the device abstraction layer API is a sub-component dedicated to a first set of system operations.

10. The method according to claim 8, wherein the graphic renderer API is a sub-component dedicated to graphic input/output operations.

11. The method according to claim 8, wherein the file and network API is a sub-component dedicated to file and network input and output.

12. The method according to claim 8, wherein the battery API measures battery power.

13. The method according to claim 8, wherein the network level API detects network availability, type of network, and link quality.

14. The method according to claim 8, wherein the cache stores a frequently used scene or a plurality of frequently used scenes.

15. The method according to claim 8, wherein the device abstraction layer API is a sub-component dedicated to a first set of system operations, wherein the graphic renderer API is a sub-component dedicated to graphic input/output operations, wherein the file and network API is a sub-component dedicated to file and network input and output, wherein the battery API measures battery power, wherein the network level API detects network availability, type of network, and link quality, and wherein the cache stores a frequently used scene or a plurality of frequently used scenes.

16. The method according to claim 15, wherein the graphic renderer API is at least one of a compositor, an overlay, a rendering, or a screenshot.

17. The method according to claim 10, wherein the graphic renderer API is at least one of a compositor, an overlay, a rendering, or a screenshot.

18. The method according to claim 1, wherein the first request for the virtual service from the first requestor device is received using an Internet protocol.

19. A system for providing a hardware agnostic virtual experience, the system comprising:
a first device comprising a runtime library including a device abstraction layer API, a graphic renderer API, a file and network API, a battery API, a network level API and a cache;
a content management server comprising virtual content;
a plurality of display devices, wherein the plurality of display devices includes an augmented or virtual reality device and another display device selected from the group consisting of a personal computer, a laptop computer, a tablet computer, or a mobile phone with a two-dimensional display;
wherein the runtime library provides for display of the virtual content on each of the plurality of display devices.

20. One or more non-transitory machine-readable media embodying program instructions that, when executed by one or more machines, cause the one or more machines to implement the method of claim 1.
